(19) United States
(12) Patent Application Publication
(10) Pub. No.: US 2010/0090780 A1
(43) Pub. Date: Apr. 15, 2010

(54) Phase shifter

(75) Inventors: In Sang Song, Daejeon (KR); Chul Soon Park, Daejeon (KR); Dong Yun Jung, Daejeon (KR); Ki Chan Eun, Daejeon (KR); Jae Jin Lee, Daejeon (KR); Seong Jun Cho, Daejeon (KR)

Correspondence Address: BACON & THOMAS, PLLC, 625 SLATERS LANE, FOURTH FLOOR, ALEXANDRIA, VA, 22314-1176, US

(73) Assignee: KOREA ADVANCED INSTITUTE OF SCIENCE AND TECHNOLOGY, Daejeon (KR)

(21) Appl. No.: 12/588,432

(22) Filed: Oct. 15, 2009

(30) Foreign Application Priority Data
Oct. 15, 2008 (KR) 10-2008-0101228

(51) Int. Cl. H01P 1/18

(52) U.S. Cl. 333/161

(57) ABSTRACT

A phase shifter includes a substrate; a signal line formed on a specific region in an upper surface of the substrate; and an air gap which is formed within the substrate and changes effective permittivity of the substrate to delay phase of a signal supplied to the signal line. The phase shifter delays a phase of a signal by controlling effective permittivity using an air gap, thereby having outstandingly low insertion loss as compared to existing phase shifters. Further, the phase shifter can be manufactured in a same length as a reference line so that the phase shifter can be in a compact size.

### CROSS-REFERENCE(S) TO RELATED APPLICATION(S)

The present invention claims priority of Korean Patent Application No. 10-2008-0101228, filed on Oct. 15, 2008, which is incorporated herein by reference.

### FIELD OF THE INVENTION

The present invention relates to a phase shifter, and, more particularly, to a phase shifter which can delay a phase of signal only by using an air gap to control effective permittivity of a substrate.

### BACKGROUND OF THE INVENTION

Pursuant to an explosive increase in demand for high-speed massive data radio communication, studies are actively going on about millimeter-wave band capable of performing ultra-high speed wide-band massive communication at a level of Gbps with 7 GHz wide bandwidth. In implementation of the radio communication system using millimeter-wave band, position and connection of circuits play very important role in terms of performance of the whole system because high-coupling in millimeter-wave has a decisive impact on the performance of the system. For this reason, system-on-package (hereinafter, SoP) technology which integrates the whole system into one module through a design even considering position and connection among devices is necessary. Beam forming circuit is another element which is necessary in implementation of the radio communication system in millimeter-wave band. In order to solve large-scale path loss which radio communication should overcome due to high oxygen uptake in millimeter-wave band (specifically, 60 GHz) and to solve NLOS (Non Line of Sight) situation unable to communicate, a beam forming circuit that forms a beam into an intended direction using an array antenna is positively necessary, and a phase shifter is the most important device in design of the beam forming circuit.

The phase shifter is widely used in RF analog signal processing unit, and is essential device for performing roles such as beam control and phase modulation in a phase array antenna. In particular, a phase shifter with low loss and high integration capability is necessary for beam forming in SoP module for radio communication in millimeter-wave band.

Such a phase shifter is largely classified into a mechanical type and an electrical type according to its structure and form, and a phase shifter of the electrical type is mainly used in a RF circuit and an analog circuit because of limitation of miniaturization in a phase shifter of the mechanical type. The phase shifter of the electrical type employs a variety of elements such as diode, field effect transistor, magnetic material, transmission line, and hybrid coupler, which can be selected depending on bandwidth, insertion loss, switching speed, resolution and other requirements in the system.

When looking into strength and weakness of several phase shifters, first, a phase shifter using magnetic materials enlarges the whole circuit size, requires high cost, and is sensitive to temperature. Thus, the phase shifter using magnetic materials is not appropriate for a use in a micromini radio communication system module.

A phase shifter using a change in permittivity generated by supplying voltage to ferroelectric requires about 100 supply voltage, and thus, it is impossible to apply the phase shifter to a radio communication system.

A phase shifter using a hybrid coupler also has a limit from its large size and the problem of terminal port processing. In addition, a phase shifter using substrate integrated waveguide (SIW) which integrates low loss characteristics of a rectangular waveguide into a planar circuit has been proposed, but it has a large loss caused at transition of a planar circuit and waveguide and, it has difficulty to the transition structure.

A technology has also been proposed to materialize a phase shift by applying different materials with very low loss, in different sizes, to the part of substrate, but it has a difficulty in manufacturing because of difference of the contraction and expansion coefficient between the different materials when combining and thus the cost of production becomes higher.

For these reasons, the phase shifter for beam forming in millimeter-wave band is mainly used as a diode-type of phase shifters which are relatively easy to materialize in compact size. Particularly, a phase shifter using a switch and a fixed phase shifter, among the diode-type phase shifters, is widely used.

The fixed phase shifter mostly uses a method to change line length. At this time, since only line length is changed, resultant phase difference lies on linear relation with frequency, having broadband characteristics. Here, an insertion loss is relatively small as the sum of the switch and the line length.

The fixed phase shifter, however, has physical difference in line length and, therefore, needs a structural change such as a meander line in order to incorporate in a system.

Using the meander line causes additional line loss due to the increase of line length, thereby amplitude of signals supplied to array antenna components becomes different, which causes problems of expanding beam width of an antenna and decreasing a gain of the antenna.

Moreover, a sudden direction change of a line that is inevitable in organizing of the meander line has a problem of causing radiation loss and a problem of coupling between phase shifters caused by getting closer between them.

As described above, the conventional phase shifters have a limit to apply to a microwave circuit and a beam forming circuit in millimeter-wave band because of a relatively large insertion loss, large size, and low degree of integration density. In addition, when considering that the performance of phase shifter has a great influence on the whole radio communication system including the beam forming circuit in millimeter-wave band, a phase shifter which has a broadband, a low loss and high degree of integration density is definitely required.

### SUMMARY OF THE INVENTION

In view of the above, the present invention provides a phase shifter capable of delaying a phase of signal by controlling effective permittivity of a substrate only using an air gap, without additional voltages or additional devices.

In accordance with one aspect of the present invention, there is provided a phase shifter, including:

a substrate;

a signal line formed on a specific region in an upper surface of the substrate; and

an air gap which is formed within the substrate and changes effective permittivity of the substrate to delay phase of a signal supplied to the signal line.

In accordance with another aspect of the present invention, there is provided a phase shifter, including:

a first metal layer formed over an upper surface of a substrate and grounded;

a second metal layer formed over a lower surface of the substrate and grounded;

a signal line formed within the substrate for transmitting a signal provided thereto;

an upper air gap and a lower air gap formed on upper part and lower part of the signal line within the substrate for causing a phase delay of the signal transmitted through the signal line.

### BRIEF DESCRIPTION OF THE DRAWINGS

The above features of the present invention will become apparent from the following description of embodiments given in conjunction with the accompanying drawings, in which:

FIG. 1 is a cross sectional view in accordance with an embodiment of the present invention illustrating a phase shifter, which is applied to a ground coplanar waveguide (GCPW) line.

FIG. 2 is a cross sectional view in accordance with another embodiment of the present invention illustrating a phase shifter, which is applied to a microstrip line.

FIG. 3 is a cross sectional view in accordance with still another embodiment of the present invention illustrating a phase shifter, which is applied to a strip line.

FIG. 4 is a perspective view of showing a configuration of the strip line phase shifter shown in FIG. 3.

FIG. 5 shows simulation results of a phase delay while altering lengths of the upper and the lower air gap in the phase shifter shown in FIG. 4.

FIG. 6 shows a portion where the line width of the signal line is optimized in order to relieve the impedance-mismatch in the strip line phase shifter shown in FIG. 4.

FIG. 7 illustrates a simulation result of a strip line phase shifter capable of shifting a phase of 30 degree.

FIG. 8 shows an insertion loss of the phase shifter of FIG. 7.

FIG. 9 is a block diagram of a beam forming circuit in millimeter-wave band to which a phase shifter of the embodiments of the present invention is applied.

### DETAILED DESCRIPTION OF THE EMBODIMENTS

Hereinafter, exemplary embodiments of the present invention will be described in detail with reference to the accompanying drawings. Like reference numerals will be given to like parts having substantially the same functions, and redundant description thereof will be omitted in the specification and the accompanying drawings.

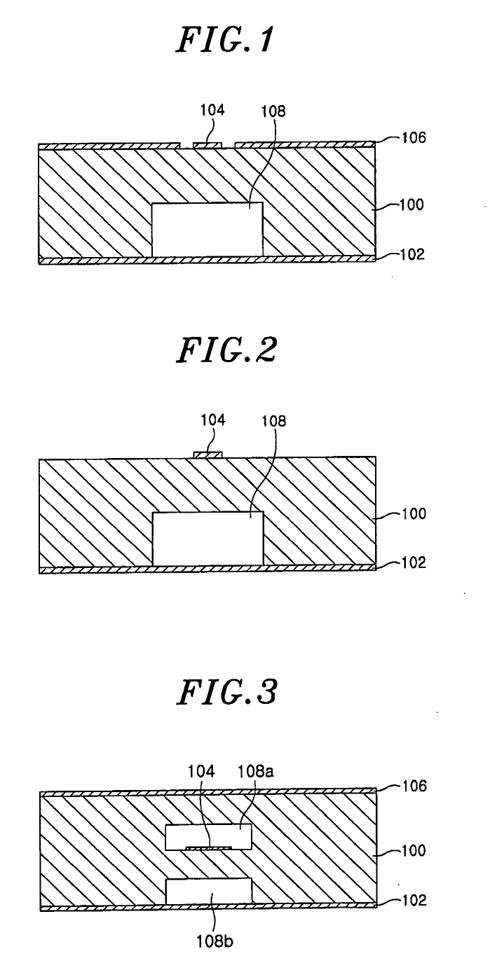

FIG. 1 is a cross sectional view in accordance with an embodiment of the present invention illustrating a phase shifter, which is applied to a ground coplanar waveguide (GCPW) line.

Referring to FIG. 1, a GCPW phase shifter includes a substrate 100 formed with a multi-layer ceramic substrate, a first metal layer 102 formed on the lower part of the substrate 100 and grounded, a signal line 104 formed on a specific region of the upper part of the substrate 100, a second metal layer 106 formed on the upper part of the substrate 100 and grounded, and an air gap 108 formed within the substrate 100 between the signal line 104 and the first metal layer 102.

FIG. 2 is a cross sectional view in accordance with another embodiment of the present invention illustrating a phase shifter, which is applied to a microstrip line.

Referring to FIG. 2, a microstrip line phase shifter has substantially similar configuration to the GCPW phase shifter shown in FIG. 1. More specifically, the microstrip line phase shifter includes the substrate 100 formed with a multi-layer ceramic substrate, the first metal layer 102 formed on the lower part of the substrate 100 and grounded, the signal line 104 formed on a specific region of the upper part of the substrate 100, and the air gap 108 formed within the substrate 100 between the signal line 104 and the first metal layer 102.

The substrate 100 is formed using multi-layer substrates technique, that is, is formed using a multi-layer ceramic substrate. More specifically, the substrate 100 including the air gap 108 may be formed by laminating several substrates with an opened region (where an air gap will be formed) and with an unopened region (where an air gap will be formed).

In the GCPW phase shifter of FIG. 1, the second metal layer 106 and the signal line 104 are formed on the upper substrate, and a first metal layer 102 is formed on the lower substrate of the multi-layer substrates composing the substrate 100. Meanwhile, in the microstrip line phase shifter of FIG. 2, the signal line 104 is formed on the upper substrate, and the first metal layer 102 is formed on the lower substrate of the multi-layer substrates composing the substrate 100.

The second metal layer 106 of the GCPW phase shifter is formed separately on either side of the signal line 104. Here, the first and second metal layer, 102 and 106, are grounded respectively and the air gap 108 is formed in a specific region within the substrate 100 on the first metal layer 102.

The air gap 108 serves to delay a phase of a signal supplied on the substrate 100 by inducing reduction in effect permittivity.

In general, the signal supplied on the signal line 104 of the substrate 100 undergoes a phase delay depending on parameters of the substrate 100, such as a permittivity, a magnetic permeability, a frequency, and a length. Using this principal, the air gap 108 is embedded in the substrate 100 to reduce the effective permittivity, thereby inducing the phase delay.

In the present invention, analog fixed phase shifter capable of shifting a phase over 360 degrees may be implemented in a subminiature size without changing the length of the substrate 100 because a volume of the air gap 108 can be linearly expressed.

On this wise, the present invention may implement a phase shifter with much less insertion loss than other phase shifters, by using the air gap 108. In this regard, optimization of the line width of the signal line 104 is required to solve impedance-mismatch which can be caused by discontinuity of characteristic impedance owing to the insertion of the air gap 108.

FIG. 3 is a cross sectional view in accordance with still another embodiment of the present invention illustrating a phase shifter, which is applied to a strip line.

Referring to FIG. 3, a strip line phase shifter has substantially similar configuration to the GCPW phase shifter shown in FIG. 1, More specifically, the strip line phase shifter includes the substrate 100 formed with a multi-layer ceramic substrate, the first metal layer 102 formed on the lower part of the substrate 100 and grounded, the second metal layer 106 formed on the upper part of the substrate 100 and grounded, the signal line 104 formed inside of the substrate 100, an upper air gap 108a including a portion of the signal line 104 and a lower air gap 108b formed inside of the substrate 100 on the first metal layer 102. Furthermore, it is preferable that the upper and the lower air gap, 108a and 108b, are arranged in upper and lower part on the basis of the signal line 104.

In the present invention, the substrate 100 including the upper and the lower air gap, 108a and 108b, is also formed using a multi-layer substrate technique.

Meanwhile, although the embodiments of the present invention have been shown that the widths of the upper and the lower air gap, 108a and 108b, are formed to be wider than the width of the signal line 104, the opposite does not matter.

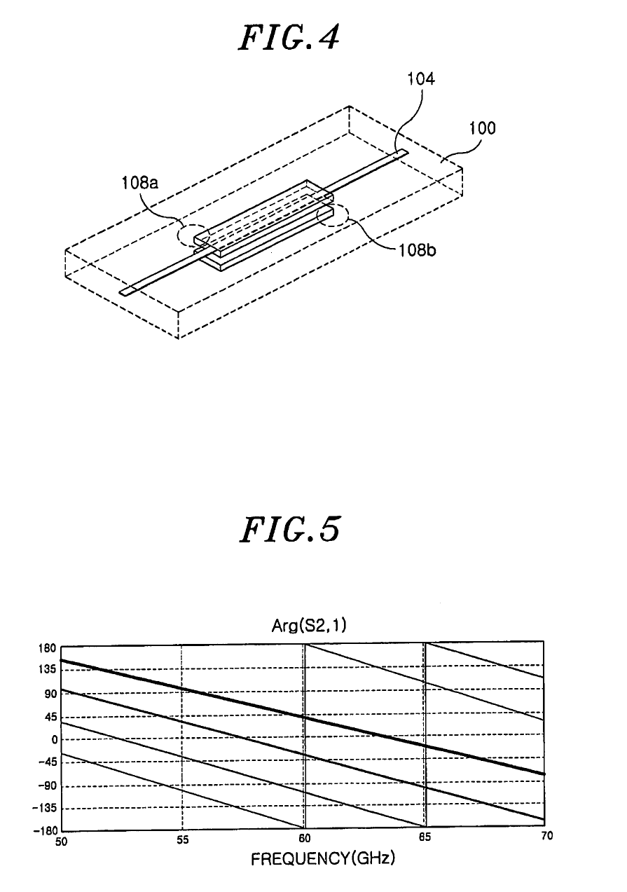

FIG. 4 is a perspective view of showing a configuration of the strip line phase shifter shown in FIG. 3.

As illustrated in FIG. 4, the signal line 104 is formed in the center of the substrate 100 in the longitudinal direction, and the upper air gap 108a and the lower air gap 108b are formed in upper and lower part on the basis of the signal line 104, respectively. Further, a center portion of the signal line 104 is placed on the bottom of the upper air gap 108a.

Provided that a signal is supplied to the signal line 104 of the phase shifter with the above configuration, a phase delay of the supplied signal occurs depending on parameters of the substrate such as a permittivity, a magnetic permeability, a frequency, and a length of the substrate 100, used to form the substrate 100. Using this principal, the upper and the lower air gap, 108a and 108b, are embedded in the upper and lower part of the signal line 104 to reduce the effective permittivity, thereby inducing a phase delay of the signal.

FIG. 5 shows simulation results of a phase delay while altering lengths of the upper and the lower air gap 108a and 108b in the phase shifter shown in FIG. 4.

As illustrated in FIG. 5, as the upper and the lower air gap, 108a and 108b, increase in the length, phase delay occurs over entire bands in TTD (True Time Delay), showing a characteristic appropriate to broadband. The phase delay followed by altering the lengths of the upper and the lower air gap 108a and 108b is approximately 70 degree/mm.

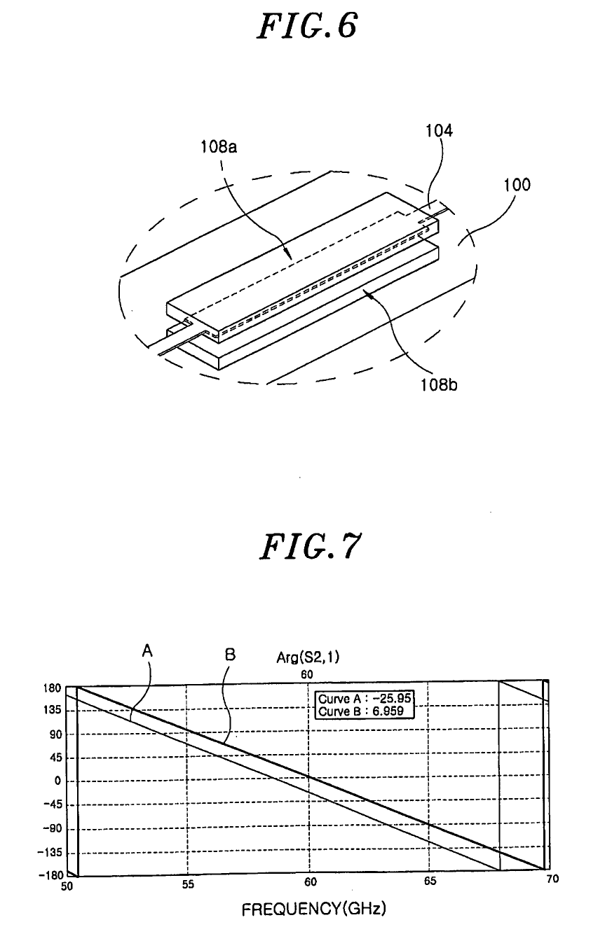

In the above configuration, characteristic impedance changes by forming the upper and the lower air gap, 108a and 108b, within the substrate 100, thereby causing impedance-mismatch. In order to relieve the impedance-mismatch, as illustrated in FIG. 6, the line width of the signal line 104 is optimized, that is, is made larger from the start point to the end point of the upper and the lower air gap, 108a and 108b, thereby obtaining reduced reflection loss, approximately 0.7 dB.

FIG. 7 illustrates a simulation result of a strip line phase shifter capable of shifting a phase of 30 degree, with the above configuration. The curve A and B represent phase characteristics of the standard line and the strip line, respectively. As shown in FIG. 7, about 30 degree of phase delay occurs at the curve B when comparing the curve B with the curve A.

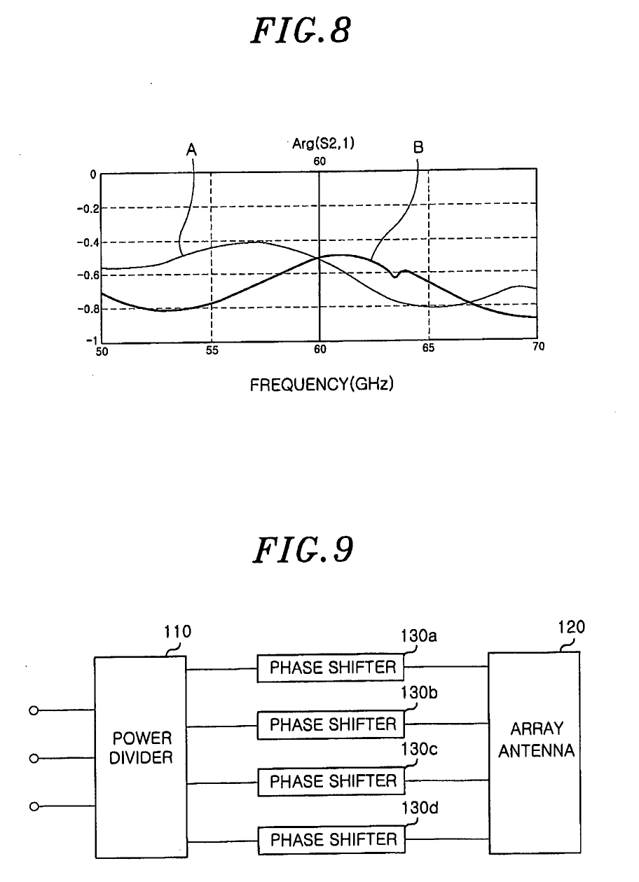

FIG. 8 shows an insertion loss of the phase shifter of FIG. 7. As shown in FIG. 8, the insertion loss is less than −0.4 dB in entire bands. Moreover, it can be seen that there is a frequency band having less insertion loss than a standard line.

FIG. 9 is a block diagram of a beam forming circuit in millimeter-wave band to which a phase shifter of the embodiments of the present invention is applied.

Referring to FIG. 9, the beam forming circuit includes power divider 110 and a plurality of phase shifters 130a, 130b, 130c, and 130d. The phase shifters 130a, 130b, 130c and 130d are located ahead of an array antenna 120. The phase shifters 130a, 130b, 130c, and 130d control phases of signals divided by the power divider 110 to supply the signals to the array antenna 120. The phase of the signals supplied to the array antenna 120 determines an angle of forming a beam, and therefore the phase shifters 130a, 130b, 130c, and 130d perform a very important role in the beam forming circuit.

The present invention delays a phase of a signal by controlling effective permittivity using an air gap, and thereby having outstandingly low insertion loss, compared to existing phase shifters.

In addition, the present invention can be manufactured in a same length as a reference line so that the phase shifter can be in a compact size. Further, the present invention has a high degree of integration as a system by using a substrate, and is capable of shifting a phase in broadband.

While the invention has been shown and described with respect to the embodiments, it will be understood by those skilled in the art that various changes and modification may be made without departing from the scope of the invention as defined in the following claims.

What is claimed is:

1. A phase shifter, comprising:
a substrate;
a signal line formed on a specific region in an upper surface of the substrate; and
an air gap which is formed within the substrate and changes effective permittivity of the substrate to delay phase of a signal supplied to the signal line.

2. The phase shifter of claim 1, further comprising:
a first metal layer formed over a lower surface of the substrate and grounded; and
a second metal layer formed on either side of the signal line and grounded.

3. The phase shifter of claim 2, wherein the air gap is formed within the substrate between the signal line and the first metal layer.

4. The phase shifter of claim 3, wherein a line width of a portion of the signal line in an area close to the air gap, is different from a line width of a remaining portion of the signal line in an area far from the air gap.

5. The phase shifter of claim 1, further comprising:
a metal layer formed on a lower surface of the substrate and grounded.

6. The phase shifter of claim 5, wherein the air gap is formed within the substrate between the signal line and the metal layer.

7. The phase shifter of claim 6, wherein a line width of a portion of the signal line in an area close to the air gap, is different from a line width of a remaining portion of the signal line in an area far from the air gap.

8. A phase shifter, comprising:
a substrate;
a first metal layer formed over an upper surface of a substrate and grounded;
a second metal layer formed over a lower surface of the substrate and grounded;
a signal line formed within the substrate for transmitting a signal provided thereto;
an upper air gap and a lower air gap formed on upper part and lower part of the signal line within the substrate for causing a phase delay of the signal transmitted through the signal line.

9. The phase shifter of claim 8, wherein a portion of the signal line is arranged within the upper air gap.

10. The phase shifter of claim 8, wherein a line width of the portion of the signal line arranged within the upper air gap is different from that of a remaining portion of the signal line.

11. The phase shifter of claim 8, wherein a line width of the portion of the signal line arranged within the upper air gap is narrower than a width of the air gaps and is wider than a width of a remaining portion of the signal line.
